(19) United States
(12) Patent Application Publication
(10) Pub. No.: US 2014/0062811 A1
(43) Pub. Date: Mar. 6, 2014

(54) CABLE, AND INPUT APPARATUS INCLUDING THE SAME, AND COMPUTER APPARATUS

(71) Applicant: SAMSUNG ELECTRO-MECHANICS CO., LTD., Suwon (KR)

(72) Inventor: Yong Jin SEOL, Gyunggi-do (KR)

(73) Assignee: SAMSUNG ELECTRO-MECHANICS CO., LTD., Suwon (KR)

(21) Appl. No.: 13/842,501

(22) Filed: Mar. 15, 2013

(30) Foreign Application Priority Data
Aug. 29, 2012 (KR) 10-2012-0095194

(51) Int. Cl. H01Q 1/46

(52) U.S. Cl. CPC H01Q 1/46
USPC 343/720; 345/163

(57) ABSTRACT

There are provided a cable having an antenna embedded therein, and an input apparatus having the same, and a computer apparatus. The cable includes: a cable body having a predetermined length and an internal space; one or more power lines disposed in the internal space of the cable body and connected between both ends of the cable body; an antenna disposed in the internal space of the cable body, and transmitting and receiving a wireless signal; and a separating part disposed in the internal space of the cable body and electrically connected between the one or more power lines and the antenna to separate a power signal transmitted through the one or more power lines and the wireless signal transmitted and received through the antenna.

### CROSS-REFERENCE TO RELATED APPLICATIONS

This application claims the priority of Korean Patent Application No. 10-2012-0095194 filed on Aug. 29, 2012, in the Korean Intellectual Property Office, the disclosure of which is incorporated herein by reference.

### BACKGROUND OF THE INVENTION

1. Field of the Invention

The present invention relates to a cable connected to an electronic apparatus such as a computer to transmit input data, and an input apparatus including the same, and a computer apparatus.

2. Description of the Related Art

Recently, various electronic devices have been used in various industrial fields such as homes, companies, and the like.

Among these electronic devices, various mobile communications devices in addition to cellular phones have been used widely in accordance with the commercialization of wireless communications.

Meanwhile, laptop computers and portable devices have mainly been used for creating documents and storing data, as main functions thereof, and have required the construction of a wired local area network (WLAN) environment in order to send created documents and stored data via e-mail.

However, recently, data transmissions have been made, even in wireless environments, with devices in which a dongle-type product capable of performing wireless communications and a peripheral component interconnection (PCI) express type product are mounted.

Cellular phones include both a circuit for communications and an antenna embedded in terminals thereof, such that they may perform communications in a wireless environment by themselves. However, in order for a device such as a laptop computer, or the like, to perform wireless communications, a modem and an antenna for wireless communications are required to be implemented in the device.

In order to provide an antenna in a device such as a laptop computer, or the like, the device should be designed in consideration of various types of noise and spatial elements.

In consideration of these elements, the antenna of the laptop computer is mainly disposed along an upper end edge of a display portion, as described in the following Related Art Document, a cellular modem has been disposed on a body side at which a keyboard is formed, and the antenna and the cellular modem have been connected via a connection member such as a cable, a substrate, or the like.

Therefore, there has been a difficulty in creating an optimal wireless environment due to loss and noise in a radio frequency (RF) signal caused by a length and a thickness of the connection member.

### RELATED ART DOCUMENT

(Patent Document 1) Korean Patent Laid-Open Publication No. 10-2012-0004133

### SUMMARY OF THE INVENTION

An aspect of the present invention provides a cable having an antenna embedded therein, and an input apparatus including the same, and a computer apparatus.

According to an aspect of the present invention, there is provided a cable including: a cable body having a predetermined length and an internal space; one or more power lines disposed in the internal space of the cable body and connected between both ends of the cable body; an antenna disposed in the internal space of the cable body, and transmitting and receiving a wireless signal; and a separating part disposed in the internal space of the cable body and electrically connected between the one or more power lines and the antenna to separate a power signal transmitted through the one or more power lines and the wireless signal transmitted and received through the antenna.

The cable may further include one or more data lines connected between the both ends of the cable body to transmit data.

The cable body may have a non-uniform thickness. The thickness of the cable body in a position in which the antenna is formed is larger than a thickness thereof in a remaining position.

The cable may be an universal serial bus (USB) interface type cable, in which two power lines having a positive power line and a ground power line and two data lines having a positive data line and a negative data line.

According to another aspect of the present invention, there is provided an input apparatus including: an input apparatus body receiving data, to be input to a main device by a user, and transmitting a data signal having the data to the main device; and a cable including a cable body having a predetermined length and an internal space, one or more power lines disposed in the internal space of the cable body and connected between both ends of the cable body to transmit a power signal from one side of the cable to the input apparatus body, an antenna disposed in the internal space of the cable body and transmitting a wireless signal from and receiving a wireless signal in the main device, a separating part disposed in the internal space of the cable body and electrically connected between the one or more power lines and the antenna to separate a power signal transmitted through the one or more power lines and the wireless signal transmitted and received through the antenna, and one or more data lines transmitting the data signal from the input apparatus body to the main device.

The input apparatus body may include: an input circuit converting the data input by the user into a form of the data signal; and a power transmitting unit removing a high frequency component included in the power lines and transmitting the power signal to the input circuit.

According to another aspect of the present invention, there is provided a computer apparatus including: a computer body processing data transmitted from a user and performing wireless communications; and an input apparatus including an input apparatus body receiving the data input to the computer body by a user and transmitting a data signal having the data to the computer body, and a cable including a cable body having a predetermined length and an internal space, one or more power lines disposed in the internal space of the cable body and connected between both ends of the cable body to transmit a power signal from one side of the cable, connected to the computer body to the input apparatus body, an antenna disposed in the internal space of the cable body and transmitting a wireless signal from and receiving a wireless signal in the computer body, a separating part disposed in the internal space of the cable body and electrically connected between the one or more power lines and the antenna to separate a power signal transmitted through the one or more power lines and the wireless signal transmitted and received through the antenna, and one or more data lines transmitting the data signal from the input apparatus body to the computer body.

The computer body may include: a wireless communications unit transmitting and receiving the wireless signal through the antenna; an interface circuit connected to the one or more power lines and the one or more data lines to process the power signal and the data signal in a corresponding interface scheme; and a diplexer separating a power signal component and a wireless signal component included in the one or more power lines.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a computer apparatus according to an embodiment of the present invention;

FIGS. 2A through 2C are schematic configuration diagrams of a cable according to the embodiment of the present invention;

FIGS. 3A and 3B are diagrams showing an example of a separating part used in the cable according to the embodiment of the present invention;

FIG. 4 is a schematic configuration diagram of an interior of an input apparatus according to the embodiment of the present invention; and

FIG. 5 is a schematic configuration diagram of an interior of a computer body of the computer apparatus according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

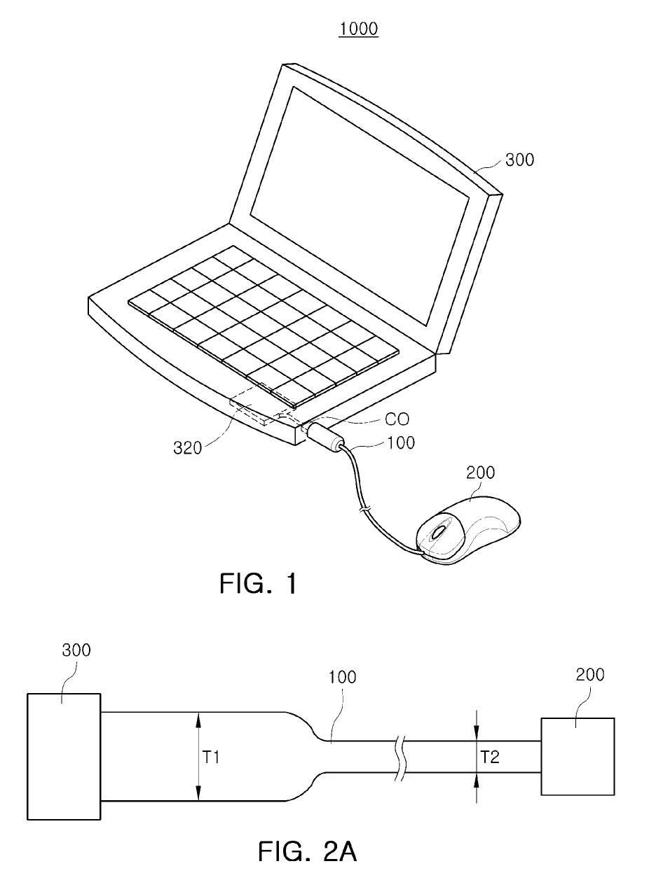

FIG. 1 is a schematic configuration diagram of a computer apparatus according to an embodiment of the present invention.

Referring to FIG. 1, a computer apparatus 1000 according to the embodiment of the present invention may include a computer body 300 and an input apparatus 200 having a cable 100 that may be connected to the computer body 300 in a universal serial bus (USB) interface scheme.

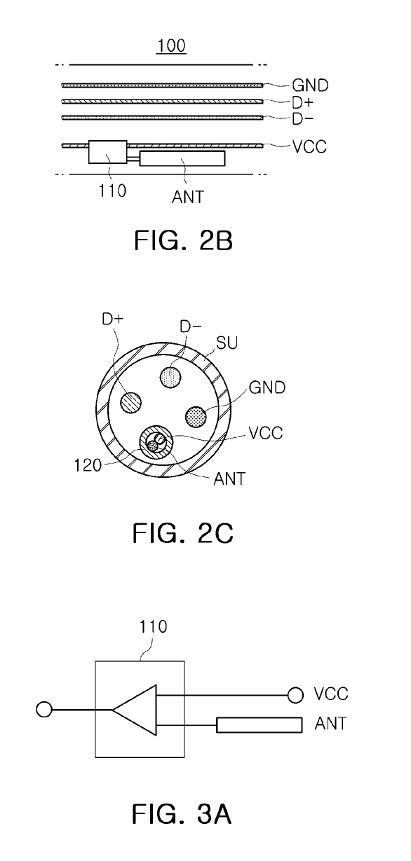

FIGS. 2A through 2C are schematic configuration diagrams of a cable according to the embodiment of the present invention.

Referring to FIGS. 2A to 2C, the cable 100 according to the embodiment of the present invention may include one or more power lines VCC and GND and one or more data lines D+ and D− that are disposed at an interior of a cable body having a predetermined length and an internal space, and an antenna ANT electrically connected to the power line VCC and connected to the computer body 300 to transmit and receive a wireless signal. The cable 100 may further include a separating part 110 separating a power signal from the power line VCC and the wireless signal from the antenna ANT.

The cable 100 according to the embodiment of the present invention may be an USB interface cable. Therefore, the cable 100 may include two power lines VCC and GND, that is, a positive power line VCC and a ground power line GND and two data lines D+ and D−, that is, a positive data line D+ and a negative data line D−.

Therefore, the cable 100 may be connected to or disconnected from the computer body 300 in the USB interface scheme and may be connected to or disconnected from the computer body 300 through a USB connector Co of the computer body 300.

The cable 100 may have a non-uniform thickness. That is, a thickness T1 of the cable 100 in a position in which the antenna is formed may be larger than a thickness T2 thereof in a remaining position. This is to prepare the internal space of the cable body in which the antenna ANT is included. In addition, in a thickness of a surface SU of the cable body, a thickness in a position in which the antenna is formed is larger than a thickness in the remaining position, to suppress a movement of the antenna ANT, thereby preventing loss, noise, and the like of a wireless signal that may be generated due to the movement of the antenna ANT caused by a use of the input apparatus 200.

In addition, the closer to the computer body 300 the position in which the antenna is formed, the more suppressed the movement of the antenna ANT.

In addition, the positive power line VCC among the power lines of the cable 100 and the antenna may be enclosed by a shielding part 120 together, separately from other lines to thereby be robust to noise.

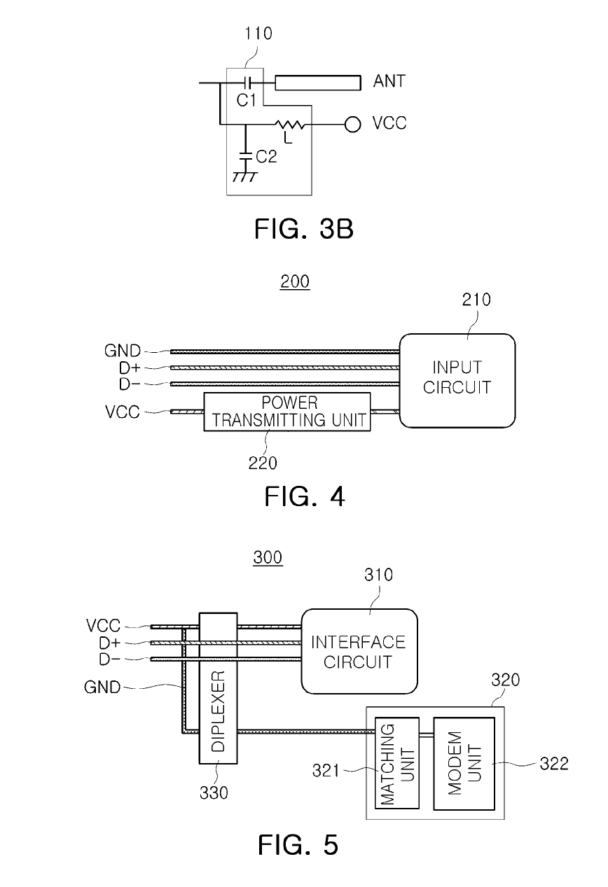

FIGS. 3A and 3B are diagrams showing an example of a separating part used in the cable according to the embodiment of the present invention.

Referring to FIG. 3A, the separating part 110 used in the cable 100 may be a diplexer and separate the wireless signal in the positive power line VCC through which the power signal is transmitted, and here, the wireless signal may be included in the positive power line VCC.

Referring to FIG. 3B, the separating part 110 used in the cable 100 may include first and second capacitors C1 and C2 and an inductor L. In this case, the first capacitor C1 may be connected between one side of the cable 100 close to the computer body 300, among one side and the other side of the cable 100, and the antenna ANT in series; the second capacitor C2 may be connected in parallel with the positive power line VCC, and the inductor L may be connected between one side of the cable 100 and the positive power line VCC in series. Likewise, the wireless signal that may be included in the positive power line VCC may be separated in the positive power line VCC through which the power signal is transmitted.

FIG. 4 is a schematic configuration diagram of an interior of an input apparatus according to the embodiment of the present invention.

Referring to FIG. 4, the input apparatus 200 according to the embodiment of the present invention may receive data, to be transmitted to the computer body 300 by a user, and transmit the received data to the computer body 300. As an example, the input apparatus 200 may be a mouse.

The input apparatus 200 may include an input circuit 210 and a power transmitting unit 220, and in this case, the input circuit 210 may signal-process the data from the user and transmit the data signal to the computer body 300 through the data lines D+ and D− of the cable 100, and the power transmitting unit 220 may transmit the power signal from the positive power line VCC to the input circuit 210 and remove a high frequency component included in the positive power line VCC, that is, the wireless signal.

FIG. 5 is a schematic configuration diagram of an interior of a computer body of the computer apparatus according to the embodiment of the present invention.

Referring to FIG. 5, the computer body 300 according to the embodiment of the present invention may include an interface circuit 310, a wireless communications unit 320, and a diplexer 330.

The interface circuit 310 may process the data signal transmitted from the data line in a preset interface scheme to allow the computer body 300 to perform an operation corresponding to data input by the user. As an example, the input apparatus 200 may transmit the data signal through the cable 100 in an USB scheme, and the interface circuit 310 may receive the data signal in the USB scheme and process the data signal.

The wireless communications unit 320 may transmit and receive the wireless signal through the antenna ANT of the cable 100. To this end, the wireless communications unit 320 may include a matching unit 321 capable of performing impedance matching and a modem unit 322 capable of controlling the transmission and the reception of the wireless signals. The modem unit 322 may perform wireless communications in a cellular scheme.

The diplexer 330 may separate the power signal and the wireless signal included in the positive power line VCC and may transmit corresponding signals to the interface circuit 310 and the wireless communications unit 320, respectively.

As set forth above, according to the embodiment of the present invention, the antenna is formed in the cable, whereby loss of a radio frequency (RF) signal and an increase in noise due to a connection member between the modem for wireless communications and the antenna within a body of a computer such as a laptop computer can be prevented.

While the present invention has been shown and described in connection with the embodiments, it will be apparent to those skilled in the art that modifications and variations can be made without departing from the spirit and scope of the invention as defined by the appended claims.

What is claimed is:

1. A cable comprising:
a cable body having a predetermined length and an internal space;
one or more power lines disposed in the internal space of the cable body and connected between both ends of the cable body;
an antenna disposed in the internal space of the cable body, and transmitting and receiving a wireless signal; and
a separating part disposed in the internal space of the cable body and electrically connected between the one or more power lines and the antenna to separate a power signal transmitted through the one or more power lines and the wireless signal transmitted and received through the antenna.

2. The cable of claim 1, further comprising one or more data lines connected between the both ends of the cable body to transmit data.

3. The cable of claim 1, wherein the cable body has a non-uniform thickness.

4. The cable of claim 3, wherein the thickness of the cable body in a position in which the antenna is formed is larger than a thickness thereof in a remaining position.

5. The cable of claim 2, wherein the cable is an universal serial bus (USB) interface type cable, in which the cable body includes two power lines having a positive power line and a ground power line and two data lines having a positive data line and a negative data line.

6. An input apparatus comprising:
an input apparatus body receiving data, to be input to a main device by a user, and transmitting a data signal having the data to the main device; and
a cable including a cable body having a predetermined length and an internal space, one or more power lines disposed in the internal space of the cable body and connected between both ends of the cable body to transmit a power signal from one side of the cable to the input apparatus body, an antenna disposed in the internal space of the cable body and transmitting a wireless signal from and receiving a wireless signal in the main device, a separating part disposed in the internal space of the cable body and electrically connected between the one or more power lines and the antenna to separate a power signal transmitted through the one or more power lines and the wireless signal transmitted and received through the antenna, and one or more data lines transmitting the data signal from the input apparatus body to the main device.

7. The input apparatus of claim 6, wherein the input apparatus body includes:
an input circuit converting the data input by the user into a form of the data signal; and
a power transmitting unit removing a high frequency component included in the power lines and transmitting the power signal to the input circuit.

8. The input apparatus of claim 6, wherein the cable body has a non-uniform thickness.

9. The input apparatus of claim 8, wherein the thickness of the cable body in a position in which the antenna is formed is larger than a thickness thereof in a remaining position.

10. The input apparatus of claim 6, wherein the cable is an universal serial bus (USB) interface type cable including two power lines having a positive power line and a ground power line and two data lines having a positive data line and a negative data line.

11. A computer apparatus comprising:
a computer body processing data transmitted from a user and performing wireless communications; and
an input apparatus including an input apparatus body receiving the data input to the computer body by a user and transmitting a data signal having the data to the computer body, and a cable including a cable body having a predetermined length and an internal space, one or more power lines disposed in the internal space of the cable body and connected between both ends of the cable body to transmit a power signal from one side of the cable, connected to the computer body to the input apparatus body, an antenna disposed in the internal space of the cable body and transmitting a wireless signal from and receiving a wireless signal in the computer body, a separating part disposed in the internal space of the cable body and electrically connected between the one or more power lines and the antenna to separate a power signal transmitted through the one or more power lines and the wireless signal transmitted and received through the antenna, and one or more data lines transmitting the data signal from the input apparatus body to the computer body.

12. The computer apparatus of claim 11, wherein the computer body includes:
a wireless communications unit transmitting and receiving the wireless signal through the antenna;
an interface circuit connected to the one or more power lines and the one or more data lines to process the power signal and the data signal in a corresponding interface scheme; and
a diplexer separating a power signal component and a wireless signal component included in the one or more power lines.

13. The computer apparatus of claim 11, wherein the input apparatus body includes:
an input circuit converting the data input from the user into a form of the data signal; and
a power transmitting unit removing a high frequency component included in the power lines and transmitting the power signal to the input circuit.

14. The computer apparatus of claim 11, wherein the cable body has a non-uniform thickness.

15. The computer apparatus of claim 14, wherein the thickness of the cable body in a position in which the antenna is formed is larger than a thickness thereof in a remaining position.

16. The computer apparatus of claim 11, wherein the cable is an universal serial bus (USB) interface type cable including two power lines having a positive power line and a ground power line and two data lines having a positive data line and a negative data line.
